(19) United States
(12) Patent Application Publication
(10) Pub. No.: US 2015/0184115 A1
(43) Pub. Date: Jul. 2, 2015

(54) STRUCTURED, LOW-WATER, LIQUID DETERGENT HAVING PARTICLES

(71) Applicant: Henkel AG & Co. KGaA, Duesseldorf (DE)

(72) Inventors: Frank Meier, Duesseldorf (DE); Dirk Weinrich, Grevenbroich (DE); Luca Bellomi, Duesseldorf (DE); Sabine Schuemann, Neuss (DE); Matthias Sunder, Duesseldorf (DE); Thorsten Ott, Moenchengladbach (DE)

(21) Appl. No.: 14/644,288

(22) Filed: Mar. 11, 2015

Related U.S. Application Data
(63) Continuation of application No. PCT/EP2013/067944, filed on Aug. 29, 2013.

(30) Foreign Application Priority Data
Sep. 14, 2012 (DE) 10 2012 216 399.9

(51) Int. Cl. C11D 17/04; C11D 3/16; C11D 1/83; C11D 17/00; C11D 3/08

(52) U.S. Cl. CPC C11D 17/043; C11D 17/0017; C11D 3/08; C11D 1/83; C11D 3/162

(57) ABSTRACT

The invention relates to a liquid detergent or cleaning agent, comprising a) 5 to 85 wt %, with respect to the entire detergent or cleaning agent, of surfactant, b) 0.1 to 10 wt %, with respect to the entire detergent or cleaning agent, of particles, c) 0.1 to 10 wt %, with respect to the entire detergent or cleaning agent, of pyrogenic silicon dioxide, and d) up to 15 wt %, with respect to the entire detergent or cleaning agent, of water. The liquid detergent or cleaning agent is clear, exhibits no creaming and/or sedimentation of the dispersed capsules, and can be part of water-soluble packagings.

### FIELD OF THE INVENTION

The present invention generally relates to a liquid detergent or cleaning agent comprising surfactant, dispersed particles, and silicon dioxide. The invention further relates to water-soluble packaging which includes such a liquid detergent or cleaning agent.

### BACKGROUND OF THE INVENTION

Detergents or cleaning agents are presently available to the consumer in numerous forms. In addition to powders and granules, these offered forms also include liquids, gels, or single-dose packages (tablets or filled pouches), for example.

In particular single-dose packages containing liquid detergents or cleaning agents are becoming increasingly popular; on the one hand they meet the consumer's demand for simplified dosing, and on the other hand, consumers increasingly prefer liquid detergents or cleaning agents.

In the formulation of liquid detergents or cleaning agents for packaging in water-soluble pouches, in particular care must be taken that the ingredients of the detergent or cleaning agent do not dissolve or solubilize the water-soluble wrapping of the pouch before it is used, thus resulting in undesirable leaks.

One ingredient which may destroy the structural integrity of the water-soluble wrapping of a pouch is water. For this reason, liquid detergents or cleaning agents for packaging in water-soluble pouches contain the smallest possible amount of water.

To enhance or prolong the olfactory perception of surfaces, such as textiles, thus treated with the detergents or cleaning agents, detergents or cleaning agents may contain fragrance capsules. The stable suspension of particles such as fragrance capsules in liquids is often problematic. In particular when the densities of the solids differ from the density of the liquid, the solids tend to sediment or float.

To achieve a homogeneous, stable distribution of the particles and thus obtain an esthetically pleasing product, the detergents or cleaning agents contain a structuring agent. Examples of suitable structuring agents are structuring gums such as xanthan gum, guar gum, locust bean gum, gellan gum, wellan gum, or carrageenan, or polyacrylate thickeners.

However, many structuring agents require water in order to develop their structuring properties in a formulation. This precludes structuring of low-water detergents or cleaning agents as used in water-soluble packaging. In addition, it is not always possible to produce yield points in systems rich in electrolyte and/or surfactant.

Accordingly, it is an object of the present invention to provide a low-water liquid detergent or cleaning agent having stable, homogeneously suspended particles which is also suitable for packaging in a water-soluble wrapping.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Liquid detergent or cleaning agent, comprising 5 to 85% by weight of surfactant, based on the total detergent or cleaning agent, selected from the group comprising nonionic surfactants, anionic surfactants, cationic surfactants, zwitterionic surfactants, and mixtures thereof; 0.1 to 10% by weight of particles, based on the total detergent or cleaning agent; 0.1 to 10% by weight of pyrogenic silicon dioxide, based on the total detergent or cleaning agent; and up to 15% by weight of water, based on the total detergent or cleaning agent.

Use of pyrogenic silicon dioxide in a liquid detergent or cleaning agent which contains surfactant, particles, and up to 15% by weight of water, based on the total detergent or cleaning agent, for the stable dispersion of the particles in the liquid detergent or cleaning agent.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The object of the present invention is achieved by a liquid detergent or cleaning agent comprising
a) 5 to 85% by weight of surfactant selected from the group comprising nonionic surfactants, anionic surfactants, cationic surfactants, zwitterionic surfactants, and mixtures thereof, based on the total detergent or cleaning agent,
b) 0.1 to 10% by weight of particles, based on the total detergent or cleaning agent,
c) 0.1 to 10% by weight of pyrogenic silicon dioxide, based on the total detergent or cleaning agent, and
d) up to 15% by weight of water, based on the total detergent or cleaning agent.

It has surprisingly been shown that the use of pyrogenic silicon dioxide results in structured low-water detergents or cleaning agents having dispersing properties, in which particles may be stably and homogeneously dispersed. In addition, the contained structured detergents or cleaning agents are clear and transparent.

In one preferred embodiment of the invention, the surfactant is selected from the group comprising nonionic surfactants, anionic surfactants, and mixtures thereof.

With regard to washing power, cleaning action, and formulability, it is advantageous to use nonionic surfactants, anionic surfactants, or a mixture thereof in the low-water liquid detergent or cleaning agent.

It is particularly preferred that the pyrogenic silicon dioxide is surface-modified, in particular hydrophobically surface-modified. When surface-modified, in particular hydrophobically surface-modified, pyrogenic silicon dioxide is used, detergents or cleaning agents having dispersing properties and which are particularly stable in storage under a variety of climatic conditions are obtained.

Particularly good, stable structuring is obtained when pyrogenic silicon dioxide that is surface-modified with hexadecylsilane or dimethyldichlorosilane is used in the liquid detergents or cleaning agents. Liquid detergents or cleaning agents containing pyrogenic silicon dioxide that is surface-modified with dimethyldichlorosilane are particularly clear. Liquid detergents or cleaning agents containing pyrogenic silicon dioxide that is surface-modified with hexadecylsilane have a yield point.

The invention further relates to water-soluble packaging which contains a liquid detergent or cleaning agent and a water-soluble wrapping, the liquid detergent or cleaning agent containing
a) 5 to 85% by weight of surfactant, based on the total detergent or cleaning agent, selected from the group comprising nonionic surfactants, anionic surfactants, cationic surfactants, zwitterionic surfactants, and mixtures thereof,
b) 0.1 to 10% by weight of particles, based on the total detergent or cleaning agent,
c) 0.1 to 10% by weight of pyrogenic silicon dioxide, based on the total detergent or cleaning agent, and
d) up to 15% by weight of water, based on the total detergent or cleaning agent.

It is preferred that the water-soluble wrapping contains polyvinyl alcohol or a polyvinyl alcohol copolymer. Water-soluble wrappings which contain polyvinyl alcohol or a polyvinyl alcohol copolymer have good stability with sufficiently high solubility in water, in particular solubility in cold water.

Further subject matter of the invention relates to the use of pyrogenic silicon dioxide in a liquid detergent or cleaning agent containing surfactant, particles, and up to 15% by weight water, based on the total detergent or cleaning agent, for the stable dispersion of the particles in the liquid detergent or cleaning agent.

The invention is explained in greater detail below with reference to examples, inter alia.

The liquid detergent or cleaning agent necessarily contains a surfactant, particles, pyrogenic silicon dioxide, and up to 15% by weight water.

The liquid detergents or cleaning agents contain surfactant(s) which is/are selected from anionic, nonionic, cationic, and/or zwitterionic surfactants. Mixtures of anionic and nonionic surfactants are preferred from a process engineering standpoint. The total surfactant content of the liquid detergent or cleaning agent is up to 85% by weight, preferably less than 75% by weight, particularly preferably less than 70% by weight, based on the total liquid detergent or cleaning agent.

The liquid detergent or cleaning agent may preferably contain nonionic surfactants. The nonionic surfactant content is preferably 5 to 40% by weight, more preferably 10 to 35% by weight, in each case based on the total liquid detergent or cleaning agent.

Suitable nonionic surfactants include alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, aminoxides, alkyl polyglucosides, and mixtures thereof.

One particularly nonionic surfactant which may be used in the liquid detergent or cleaning agent is an alkoxylated oxo alcohol. Oxo alcohols are primary, partially branched higher alcohols obtained in the oxo synthesis. Oxo aldehydes or their primary aldo condensation products are converted to the corresponding oxo alcohols by catalytic hydrogenation.

A C₁₃₋₁₅ oxo alcohol having 7 EO, a C₁₃₋₁₅ oxo alcohol having 8 EO, or a mixture of these two oxo alcohols is preferably used as nonionic surfactant in the liquid detergents or cleaning agents.

In particular alkoxylated fatty alcohols are suitable as further nonionic surfactants. These are preferably ethoxylated, in particular primary alcohols containing in particular 8 to 18 C atoms and an average of 4 to 12 moles ethylene oxide (EO) per mole alcohol. In particular alcohol ethoxylates containing 12 to 18 C atoms, for example of coconut alcohol, palm alcohol, tallow fat alcohol, or oleyl alcohol, and an average of 5 to 8 EO per mole alcohol are preferred. The preferred ethoxylated alcohols include, for example, C₁₂₋₁₄ alcohols having 4 EO or 7 EO, C₉₋₁₁ alcohols having 7 EO, C₁₂₋₁₈ alcohols having 5 EO or 7 EO, and mixtures thereof. The stated degrees of ethoxylation represent statistical average values, which for a particular product may correspond to a whole number or a fractional number. Preferred alcohol ethoxylates have a narrowed homolog distribution (narrow range ethoxylates (NRE)). In addition to these nonionic surfactants, fatty alcohols having greater than 12 EO may also be used. Examples of such are tallow fat alcohol having 14 EO, 25 EO, 30 EO, or 40 EO. Nonionic surfactants containing the EO and PO groups together in the molecule are also usable according to the invention. Also suitable is a mixture of a (more highly) branched ethoxylated fatty alcohol and an unbranched ethoxylated fatty alcohol, such as a mixture of a C₁₆₋₁₈ fatty alcohol having 7 EO and 2-propylheptanol having 7 EO.

The content of alkoxylated oxo alcohol is preferably 5 to 40% by weight, more preferably 10 to 35% by weight, in each case based on the total liquid detergent or cleaning agent. The quantity of further nonionic surfactants is preferably less than 5% by weight, more preferably less than 2% by weight, particular preferably less than 1% by weight, in each case based on the total quantity of liquid detergent or cleaning agent.

It is preferred that the liquid detergent or cleaning agent also contains an anionic surfactant. The content of anionic surfactant is preferably 5 to 50% by weight, more preferably 10 to 40% by weight, in each case based on the total liquid detergent or cleaning agent.

Suitable anionic surfactants include alkylbenzenesulfonic acid salts, olefin sulfonic acid salts, C₁₂₋₁₈ alkanesulfonic acid salts, salts of sulfuric acid monoesters with a fatty alcohol, fatty acid soaps, salts of sulfuric acid monoesters with an ethoxylated fatty alcohol, or a mixture of two or more of these anionic surfactants. Of these anionic surfactants, alkylbenzenesulfonic acid salts, fatty acid soaps, and mixtures thereof are particularly preferred.

C₉₋₁₃ alkylbenzene sulfonates, olefin sulfonates, i.e., mixtures of alkene and hydroxyalkane sulfonates, and disulfonates as obtained, for example, from C₁₂₋₁₈ monoolefins containing terminal or internal double bonds by sulfonation with gaseous sulfur trioxide followed by alkaline or acidic hydrolysis of the sulfonation products, are preferably suitable as surfactants of the sulfonate type. Also suitable are C₁₂₋₁₈ alkane sulfonates and the esters of α-sulfo fatty acids (ester sulfonates), for example the α-sulfonated methyl esters of hydrogenated coconut, palm kernel, or tallow fatty acids.

The salts of sulfuric acid half-esters of the C₁₂-C₁₈ fatty alcohols, for example coconut fat alcohol, tallow fat alcohol, lauryl, myristyl, cetyl, or stearyl alcohol, or the C₁₀-C₂₀ oxo alcohols and the half-esters of secondary alcohols having these chain lengths, are preferred as alk(en)yl sulfates. The C₁₂-C₁₆ alkyl sulfates and C₁₂-C₁₅ alkyl sulfates as well as C₁₄-C₁₅ alkyl sulfates are preferred from a technical detergent standpoint. 2,3-alkyl sulfates are also suitable anionic surfactants.

Fatty alcohol ether sulfates such as the sulfuric acid monoesters of straight-chain or branched C₇₋₂₁ alcohols, such as 2-methyl-branched C₉₋₁₁ alcohols having an average of 3.5 moles ethylene oxide (EO) or C₁₂₋₁₈ fatty alcohols having 1 to 4 EO, ethoxylated with 1 to 6 moles of ethylene oxide, are also suitable.

Fatty acid soaps are further suitable anionic surfactants. Saturated and unsaturated fatty acid soaps such as the salts of lauric acid, myristic acid, palmitic acid, stearic acid, (hydrogenated) erucic acid, and behenic acid, and in particular soap mixtures derived from natural fatty acids, for example coconut, palm kernel, olive oil, or tallow fatty acids, are suitable.

The anionic surfactants, including the fatty acid soaps, may be present in the form of their sodium, potassium, magnesium, or ammonium salts. The anionic surfactants are preferably present in the form of their sodium salts or ammonium salts. Amines which may be used for the neutralization are preferably choline, triethylamine, monoethanolamine, diethanolamine, triethanolamine, methylethylamine, or a mixture thereof, with monoethanolamine being preferred.

In one very particularly preferred embodiment, the liquid detergent or cleaning agent contains an alkylbenzenesulfonic acid, in particular C₉₋₁₃ alkylbenzenesulfonic acid, which is neutralized with monoethanolamine, and/or a fatty acid which is neutralized with monoethanolamine.

The neutralization with amines, unlike the case for bases such as NaOH or KOH, does not result in the formation of water. Low-water detergents or cleaning agents may thus be produced which are directly suitable for use in water-soluble pouches.

The total quantity of anionic surfactant and nonionic surfactant in the liquid detergent or cleaning agent is preferably up to 85% by weight, preferably 40 to 75% by weight, particularly preferably 50 to 70% by weight, based on the total liquid detergent or cleaning agent.

The detergent or cleaning agent is liquid. The detergent or cleaning agent may contain water, the water content being less than 15% by weight, more preferably less than 10% by weight, in each case based on the total detergent or cleaning agent.

In addition to these constituents, a liquid detergent or cleaning agent contains particles having a diameter of preferably 1 to 300 μm, more preferably 5 to 100 μm, along their largest spatial dimension.

Within the meaning of the present invention, particles may be capsules, abrasive substances, or also powders, granules, or compositions of compounds which are insoluble in the liquid detergent or cleaning agent. In one preferred embodiment, the particles are capsules. In another preferred embodiment, the particles are compounds which are insoluble in the liquid detergent or cleaning agent, in particular cellulose derivatives such as carboxymethylcellulose or hydroxyalkyl methylcelluloses, or pearlescent compounds.

The term “capsule” is understood to mean on the one hand aggregates having a core-shell structure, and on the other hand, aggregates having a matrix. Core-shell capsules contain at least one solid or liquid core which is enclosed by at least one continuous shell, in particular a shell made of polymer(s).

Sensitive chemically or physically incompatible and volatile components (active ingredients) of the liquid detergent or cleaning agent may be incorporated into the interior of the capsules in a manner that is stable during storage and transport. The capsules may contain, for example, optical brighteners, surfactants, complex-forming agents, bleaching agents, bleaching activators, dyes and fragrances, antioxidants, builders, enzymes, enzyme stabilizers, antimicrobial active substances, graying inhibitors, anti-redeposition agents, pH adjusters, electrolytes, washing power enhancers, vitamins, proteins, foam inhibitors, and UV absorbers. The fillings of the capsules may be solids, or liquids in the form of solutions, emulsions, or suspensions.

Within the scope of manufacturing, the capsules may have any arbitrary shape, but are preferably approximately spherical. The diameter of the capsules along their largest spatial dimension may be between 1 μm and 100 μm, preferably between 5 μm and 40 μm, depending on the components contained inside the capsules and their application.

Alternatively, particles may be used which do not have a core-shell structure, but, rather, in which the active ingredient is distributed in a matrix made of a matrix-forming material. Such particles are also referred to as “speckles.”

For these materials, the matrix is formed, for example, by gelling, polyanion-polycation interactions, or polyelectrolyte-metal ion interactions, and is well known in the prior art, as is the production of particles containing these matrix-forming materials. One example of a matrix-forming material is alginate. For producing alginate-based speckles, an aqueous alginate solution which also contains the active ingredient(s) to be incorporated is added dropwise, and subsequently hardened in a precipitation bath containing Ca′ ions or AI³⁺ ions. Alternatively, other matrix-forming materials may be used instead of alginate.

The release of the active ingredients from the capsules typically takes place by destruction of the shell or the matrix due to mechanical, thermal, chemical, or enzymatic action.

In one preferred embodiment, the liquid detergents or cleaning agents contain capsules which contain one or more fragrances.

The cellulose derivative is preferably selected from the group comprising carboxymethylcellulose (CMC), an ethersulfonic acid salt of cellulose, an acidic sulfuric acid ester salt of cellulose, methylcellulose, ethylcellulose, hydroxyethylcellulose, hydroxypropylcellulose, hydroxypropyl methylcellulose, methylhydroxy ethylcellulose, methylcarboxy methylcellulose, ethylhydroxy ethylcellulose, or a mixture of these cellulose derivatives. Particularly preferred cellulose derivatives include carboxymethylcellulose, hydroxypropyl methylcellulose, methylhydroxy ethylcellulose, or mixtures of two or more of these cellulose derivatives. The diameter along the largest spatial dimension of the cellulose derivatives is preferably 5 to 250 μm. An advantage of incorporating cellulose derivatives in dispersed particle form is that due to the presence of a cellulose derivative, no undesirable increase in viscosity of the liquid detergent or cleaning agent results.

Examples of suitable pearlescent compounds include mica, metal oxide-coated mica, silica-coated mica, bismuth oxychloride-coated mica, bismuth oxychloride, glass, metal oxide-coated glass, polyester glitter, and/or metal glitter. The diameter along the largest spatial dimension of the pearlescent compounds is preferably 5 to 25 μm. An example of a pearlescent compound whose use is particularly preferred is COSMIC SW-20 (from Wunzhou Kuncai Pearlescent Pigment Co., LTD).

Alternatively, the particles may include abrasive substances such as plastic or calcium carbonate beads, or also powders, granules, or compositions of compounds which are insoluble in the liquid detergent or cleaning agent.

The particles may be stably dispersed in the liquid detergents or cleaning agents. The term “stable” means that the detergents or cleaning agents are stable at room temperature over a period of at least 4 weeks, preferably at least 6 weeks, without the particles creaming or sedimenting in the agent.

In one preferred embodiment of the invention, the liquid detergent or cleaning agent contains the same or different particles in quantities of 0.1 to 10% by weight, in particular 0.15 to 8% by weight, very particularly preferably 0.2 to 5% by weight.

Another essential constituent of the liquid detergent or cleaning agent is pyrogenic silicon dioxide. Synthetic silicon dioxide is produced by different processes on an industrial scale. The production of synthetic silicon dioxide on an industrial scale is carried out primarily via precipitation processes, starting with water glass. Silicon dioxide produced in this way is referred to as precipitated silicic acid, silica gel, or colloidal silicic acid, depending on the process conditions. Pyrogenic silicon dioxide is produced in an oxyhydrogen flame, starting with liquid chlorosilanes such as silicon tetrachloride (SiCl₄).

It has been shown that pyrogenic silicon dioxide is particularly well suited for structuring low-water detergents or cleaning agents.

Detergents or cleaning agents having dispersing properties, and which in particular are clear and stable in storage, are obtained when the pyrogenic silicon dioxide is surface-modified, in particular hydrophobically surface-modified. Particularly good, stable structuring is obtained when pyrogenic silicon dioxide that is surface-modified with hexadecylsilane or dimethyldichlorosilane is used in the liquid detergents or cleaning agents.

Suitable pyrogenic silicon dioxide is available, for example, from Evonik under the trade names Aerosil® R 972, Aerosil® R 974, and Aerosil® R 816.

The quantity of pyrogenic silicon dioxide in the liquid detergent or cleaning agent is preferably 0.1 to 10% by weight, particularly preferably 0.2 to 2% by weight.

The liquid detergents or cleaning agents which are structured with pyrogenic silicon dioxide preferably have a viscosity in the range of 200 to 2000 mPas, more preferably in the range of 300 to 800 mPas. The viscosity is determined at 20° C. using a Brookfield Model RVT rotational viscometer at 20 rpm.

In addition, the liquid detergents or cleaning agents which are structured with pyrogenic silicon dioxide that is surface-modified with hexadecylsilane have a yield point of at least 0.1 Pa, preferably at least 0.3 Pa.

The yield points of the liquid detergents or cleaning agents were measured at 20° C. using a Model AR G2 rotational rheometer from TA Instruments, which is a so-called shear stress controlled rheometer.

Various methods for measuring a yield point using a shear stress controlled rheometer are described in the literature which are known to those skilled in the art.

Within the scope of the present invention, the following procedure was followed for determining the yield points:

The samples in a rheometer were subjected to a shear stress s(t) which increased with time. For example, over a period of 10 minutes the shear stress may be increased form the smallest possible value (2 mPa, for example) to 10 Pa, for example. The deformation y of the sample was measured as a function of this shear stress. The deformation was plotted as a function of the shear stress in a double logarithmic plot. Provided that the sample being examined has a yield point, a clear distinction may be made between two areas in this plot. Below a certain shear stress, purely elastic deformation occurs. The slope of the curve y(σ) (log-log plot) in this area is one. Above this shear stress, the yield range begins, and the slope of the curve increases abruptly. The shear stress at which the curve bends, i.e., the transition from elastic to plastic deformation, marks the yield point. The inflection point may be conveniently determined by applying tangents to the two curve portions. Samples with no yield point do not have a characteristic bend in the function y(σ).

In addition to the surfactants, the pyrogenic silicon dioxide, and the particles, the detergent or cleaning agent may contain additional ingredients which further improve the process engineering and/or esthetic properties of the detergent or cleaning agent. Within the scope of the present invention, the detergent or cleaning agent preferably also contains one or more substances from the group of builders, bleaching agents, enzymes, electrolytes, pH adjusters, fragrances, fragrance carriers, fluorescence agents, dyes, hydrotopes, foam inhibitors, silicone oils, anti-redeposition agents, graying inhibitors, shrinkage inhibitors, anti-crease agents, dye transfer inhibitors, antimicrobial active substances, nonaqueous solvents, germicides, fungicides, antioxidants, preservatives, corrosion inhibitors, anti-static agents, bittering agents, ironing aids, repellent and impregnation agents, skin care active substances, swelling and anti-slip agents, softening components, and UV absorbers.

The liquid detergent or cleaning agent may be filled into a water-soluble wrapping, and may thus be a constituent of a water-soluble packaging.

A water-soluble packaging contains a water-soluble wrapping in addition to the liquid detergent or cleaning agent. The water-soluble wrapping is preferably formed by a water-soluble film material.

Such water-soluble packaging may be produced either by vertical form-fill-seal (VFFS) methods or hot-forming methods.

The hot-forming method generally includes the formation of a first layer made of a water-soluble film material to form indentations for accommodating a composition therein, filling the composition into the indentations, wrapping the indentations filled with the composition with a second layer made of a water-soluble film material, and sealing the first and second layers to one another at least around the indentations.

The water-soluble wrapping is preferably formed from a water-soluble film material selected from the group comprising polymers or polymer mixtures. The wrapping may be formed from one, two, or more layers made of the water-soluble film material. The water-soluble film material of the first layer and of the additional layers, if present, may be the same or different.

The water-soluble packaging, which includes the liquid detergent or cleaning agent and the water-soluble wrapping, may have one or more chambers. The liquid detergent or cleaning agent may be contained in one or more chambers, if present, of the water-soluble wrapping. The quantity of liquid detergent or cleaning agent preferably corresponds to a full dose or one-half dose necessary for one washing operation.

It is preferred that the water-soluble wrapping contains polyvinyl alcohol or a polyvinyl alcohol copolymer.

Suitable water-soluble films for manufacturing the water-soluble wrapping are preferably based on a polyvinyl alcohol or a polyvinyl alcohol copolymer having a molecular weight in the range of 10,000 to 1,000,000 gmol⁻¹, preferably 20,000 to 500,000 gmol⁻¹, particularly preferably 30,000 to 100,000 gmol⁻¹, and in particular 40,000 to 80,000 gmol⁻¹.

Polyvinyl alcohol is typically produced by hydrolysis of polyvinyl acetate, since a direct synthetic route is not possible. The same applies for polyvinyl alcohol copolymers, which are correspondingly produced from polyvinyl acetate copolymers. It is preferred when at least one layer of the water-soluble wrapping contains a polyvinyl alcohol having a degree of hydrolysis of 70 to 100 mol-%, preferably 80 to 90 mol-%, particularly preferably 81 to 89 mol-%, and in particular 82 to 88 mol-%.

In addition, a polymer selected from the group comprising (meth)acrylic acid-containing (co)polymers, polyacrylamides, oxazoline polymers, polystyrene sulfonates, polyurethanes, polyesters, polyethers, polylactic acid, or mixtures of these polymers may be added to a polyvinyl alcohol-containing film material which is suitable for manufacturing the water-soluble wrapping. Polylactic acids are a preferred additional polymer.

In addition to vinyl alcohol, preferred polyvinyl alcohol copolymers include dicarboxylic acids as additional monomers. Suitable dicarboxylic acids are itaconic acid, malonic acid, succinic acid, and mixtures thereof, with itaconic acid being preferred.

Likewise preferred polyvinyl alcohol copolymers include, in addition to vinyl alcohol, an ethylenically unsaturated carboxylic acid, its salt, or its ester. In addition to vinyl alcohol, such polyvinyl alcohol copolymers particularly preferably contain acrylic acid, methacrylic acid, acrylic acid ester, methacrylic acid ester, or mixtures thereof.

It may be preferred that the film material contains further additives. The film material may contain, for example, softeners such as dipropylene glycol, ethylene glycol, diethylene glycol, propylene glycol, glycerin, sorbitol, mannitol, or mixtures thereof. Examples of further additives include release aids, fillers, crosslinking agents, surfactants, antioxidants, UV absorbers, antiblocking agents, non-stick agents, or mixtures thereof.

Films marketed by MonoSol LLC, for example under the trade names M8630, C8400, or M8900 are suitable water-soluble films for use in the wrappings of the water-soluble packaging according to the invention. Other suitable films include films with the trade names Solublon® PT, Solublon® GA, Solublon® KC, or Solublon® KL from Aicello Chemical Europe GmbH, or VF-HP films from Kuraray.

The water-soluble packaging may have a dimensionally stable or a deformable design.

The water-soluble packaging may be designed as a dimensionally stable receptacle, for example in the form of a capsule, box, can, or container.

In principle, however, it is also possible and preferred to form the water-soluble packaging as a nondimensionally stable container, for example as a pouch. The shape of this type of water-soluble packaging may be adapted to a great extent to the use conditions. Various shapes such as tubes, cushions, cylinders, bottles, or disks are suitable.

The water-soluble packaging may have one or more chambers for storing one or more agents.

The low-water detergents or cleaning agents according to the invention and the water-soluble packaging according to the invention containing the low-water detergent or cleaning agent may be used for washing or for cleaning textile or hard surfaces by preparing a washing or cleaning solution, using the low-water detergent or cleaning agent according to the invention or the water-soluble packaging according to the invention containing the low-water detergent or cleaning agent, and bringing the washing or cleaning solution into contact with the surface to be treated.

### EXAMPLE

Liquid detergents or cleaning agents were produced using customary, known methods and processes. Table 1 below shows the compositions of four detergents or cleaning agents E1 through E4 according to the invention, and six detergents or cleaning agents V1 through V6 not according to the invention.

TABLE 1
Liquid detergents or cleaning agents E1 through E4 and V1 through V6
(all quantities expressed in % by weight active ingredient, based on the composition)

| Ingredient | E1 | E2 | E3 | E4 | V1 | V2 | V3 | V4 | V5 | V6 |
|---|---|---|---|---|---|---|---|---|---|---|
| C₁₀—C₁₃ | 21 | 21 | 21 | 21 | 21 | 21 | 21 | 21 | 21 | 21 |
| alkylbenzenesulfonic | | | | | | | | | | |
| acid | | | | | | | | | | |
| C₁₃—C₁₅ oxo alcohol | 22.5 | 22.5 | 22.5 | 22.5 | 22.5 | 22.5 | 22.5 | 22.5 | 22.5 | 22.5 |
| having 8 EO | | | | | | | | | | |
| Pyrogenic SiO₂¹ | 1 | — | — | 2 | — | — | — | — | — | — |
| Pyrogenic SiO₂² | — | 1 | — | — | — | — | — | — | — | — |
| Pyrogenic SiO₂³ | — | — | 1 | — | — | — | — | — | — | — |
| Acrylic polymer⁴ | — | — | — | — | 1 | — | — | — | — | — |
| Acrylic polymer⁵ | — | — | — | — | — | 1 | — | — | — | — |
| Cationic acrylic | — | — | — | — | — | — | 0.5 | — | — | — |
| polymer⁶ | | | | | | | | | | |
| Xanthan | — | — | — | — | — | — | — | 0.4 | — | — |
| Methacrylic acid | — | — | — | — | — | — | — | — | 1 | — |
| Crosslinked acrylic | — | — | — | — | — | — | — | — | — | 1 |
| polymer⁷ | | | | | | | | | | |
| C₁₂₋₁₈ fatty acid | 17.5 | 17.5 | 17.5 | 17.5 | 17.5 | 17.5 | 17.5 | 17.5 | 17.5 | 17.5 |
| Glycerin | 13 | 13 | 13 | 13 | 13 | 13 | 13 | 13 | 13 | 13 |
| 1, 2-Propanediol | 12.5 | 12.5 | 12.5 | 11.5 | 12.5 | 12.5 | 13.0 | 13.1 | 12.5 | 12.5 |
| Ethanol | 3.26 | 3.26 | 3.26 | 3.26 | 3.26 | 3.26 | 3.26 | 3.26 | 3.26 | 3.26 |
| Phosphonate | 0.3 | 0.3 | 0.3 | 0.3 | 0.3 | 0.3 | 0.3 | 0.3 | 0.3 | 0.3 |
| Monoethanolamine | 6.4 | 6.4 | 6.4 | 6.4 | 6.4 | 6.4 | 6.4 | 6.4 | 6.4 | 6.4 |
| Dyes, enzymes | 0.8 | 0.8 | 0.8 | 0.8 | 0.8 | 0.8 | 0.8 | 0.8 | 0.8 | 0.8 |
| (cellulase, amylase, | | | | | | | | | | |
| protease), optical | | | | | | | | | | |
| brighteners, and free | | | | | | | | | | |
| fragrance | | | | | | | | | | |
| Water | 1.74 | 1.74 | 1.74 | 1.74 | 1.74 | 1.74 | 1.74 | 1.74 | 1.74 | 1.74 |

¹Pyrogenic silicon dioxide post-treated with hexadecylsilane
²Pyrogenic silicon dioxide, having a specific surface (BET) of 110 ± 20 m²/g, treated with dimethyldichlorosilane
³Pyrogenic silicon dioxide, having a specific surface (BET) of 170 ± 20 m²/g, treated with dimethyldichlorosilane
⁴Polygel W30 (from 3V Sigma)
⁵Polygel W 400 (from 3V Sigma)
⁶Rheovis CSP (from BASF)
⁷Carbopol ® Aqua 30 (from Noveon)

The four detergents or cleaning agents E1 through E4 were clear, and stable for over 8 weeks under various climatic conditions. The detergents or cleaning agents E2 and E3 had a particularly clear appearance. The detergent or cleaning agent E1 had a yield point of 0.3 Pa. The detergent or cleaning agent E4 had a yield point of 0.7 Pa.

0.2% by weight of fragrance capsules having a particle diameter d₉₀ of less than 15 μm were homogeneously dispersed in each case in the two detergents or cleaning agents E1 and E2. 0.4% by weight of a mica- and TiO₂-containing pearlescent compound having a diameter in the range of 5 to 25 μm was dispersed in the detergent or cleaning agent E3. 1.5% by weight of carboxymethylcellulose having a particle diameter in the range of 5 to 250 μm was dispersed in the detergent or cleaning agent E4.

The four particle-containing detergent or cleaning agents E1 through E4 were stable for over 8 weeks under various climatic conditions, and showed no appreciable creaming and/or sedimentation of the particular dispersed particles.

For the detergents or cleaning agents V1 and V2, upon addition of the acrylic polymer or the acrylic copolymer in the production process, gel-like clumps formed which did not dissolve, even in the further course of the production process. In the case of the detergent or cleaning agent V3, a translucent composition was obtained which showed heavy precipitation after a few days. In the case of the detergent or cleaning agent V4, clumps also formed during the production process; the detergent or cleaning agent V5 was clear, but showed slight precipitation after 4 weeks storage, in particular under storage conditions at temperatures above 30° C. In the case of the detergent or cleaning agent V6, a cloudy composition was obtained which separated into two phases after three days.

For producing water-soluble packaging containing the detergents or cleaning agents E1 through E4, a film of type M 8630 (from Monosol) having a thickness of 76 μm was drawn by vacuum into a cavity to form an indentation. The indentation was subsequently filled with 30 mL of one of the liquid detergents or cleaning agents E1, E2, E3, or E4. After covering the indentations filled with the agent with a second layer of a film of type M 8630, the first and second layers were sealed together. The sealing temperature was 150° C., and the sealing duration was 1.1 seconds.

After 4, 8, and 12 weeks storage time of the water-soluble packaging containing the detergents or cleaning agents E1 through E4 under various climatic conditions, no solubilization or dissolution of the water-soluble wrapping was observed. In addition, no pores or holes, which likewise would result in escaping product or leaks, were identified. Furthermore, no appreciable creaming and/or sedimentation of the particular dispersed particles was observed.

Water-soluble packaging containing the detergents or cleaning agents E1 through E4 dissolved without residues in washing operations at temperatures in the range of 20 to 95° C., and showed very good cleaning performance. In particular water-soluble packaging containing the detergent or cleaning agent E4 showed cleaning performance with very high graying inhibition over multiple uses.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. Liquid detergent or cleaning agent, comprising
a) 5 to 85% by weight of surfactant, based on the total detergent or cleaning agent, selected from the group comprising nonionic surfactants, anionic surfactants, cationic surfactants, zwitterionic surfactants, and mixtures thereof,
b) 0.1 to 10% by weight of particles, based on the total detergent or cleaning agent,
c) 0.1 to 10% by weight of pyrogenic silicon dioxide, based on the total detergent or cleaning agent, and
d) up to 15% by weight of water, based on the total detergent or cleaning agent.

2. Liquid detergent or cleaning agent according to claim 1, wherein the surfactant is selected from the group comprising nonionic surfactants, anionic surfactants, and mixtures thereof.

3. Liquid detergent or cleaning agent according to claim 1, wherein the pyrogenic silicon dioxide is surface-modified.

4. Liquid detergent or cleaning agent according to claim 3, wherein the pyrogenic silicon dioxide is hydrophobically surface-modified.

5. Liquid detergent or cleaning agent according to claim 3, wherein the pyrogenic silicon dioxide is surface-modified with hexadecylsilane or dimethyldichlorosilane.

6. Liquid detergent or cleaning agent according to claim 1, wherein the liquid detergent or cleaning agent contains the pyrogenic silicon dioxide in a quantity of 0.2 to 2% by weight, based on the total detergent or cleaning agent.

7. Liquid detergent or cleaning agent according to claim 1, wherein the liquid detergent or cleaning agent has a viscosity in the range of 200 to 2000 mPas (20° C., Brookfield Model RVT rotational viscometer at 20 rpm).

8. Water-soluble packaging comprising a liquid detergent or cleaning agent according to claim 1 and a water-soluble wrapping.

9. Water-soluble packaging according to claim 8, wherein the water-soluble wrapping contains polyvinyl alcohol or a polyvinyl alcohol copolymer.
